(19) United States
(12) Patent Application Publication
(10) Pub. No.: US 2007/0284941 A1
(43) Pub. Date: Dec. 13, 2007

(54) Power Cross-Coupler for Power over Ethernet

(76) Inventor: Steven Andrew Robbins, (US)

Correspondence Address: Steve Robbins, Unit A, 26007 Alizia Canyon Drive, Calabasas, CA, 91302, US

(21) Appl. No.: 11/539,619

(22) Filed: Oct. 6, 2006

Related U.S. Application Data
(60) Provisional application No. 60/804,217, filed on Jun. 8, 2006.

(51) Int. Cl. H02J 3/02

(52) U.S. Cl. 307/2

(57) ABSTRACT

The invention includes a method and an apparatus with several embodiments for cross-coupling DC power between the data and spare twisted-pairs in a Power over Ethernet (PoE) system. In one embodiment, power output by an endspan Power Sourcing Equipment (PSE) on the Alternative-B twisted-pairs (the spare pairs) is DC-coupled to the Alternative-A twisted-pairs (the data pairs), while Ethernet data is AC-coupled straight through, thus allowing an Alt-B endspan PSE to be used in tandem with a midspan PSE to power a dual-load Powered Device (PD). In another embodiment, the transfer of power from Alt-B to Alt-A is performed inside a novel midspan PSE, thus allowing a dual-load PD to be fully powered by cascading two ports of said novel midspan PSE, rather than using an endspan PSE and a midspan PSE in tandem.

### CROSS-REFERENCE TO RELATED APPLICATIONS

This application claims priority from U.S. Provisional Patent Application No. 60/804,217 titled A Passive Swapper for PoE Power Sources, filed on Jun. 8, 2006.

### TECHNICAL FIELD OF THE INVENTION

The invention relates generally to the field of Power over Ethernet (PoE)—a system that provides limited DC power over computer networking cables—and more specifically to the subject of providing increased power for PoE applications.

### BACKGROUND OF THE INVENTION

The IEEE issued an amendment to IEEE Std 802.3™-2002; this amendment, titled Data Terminal Equipment (DTE) Power via Media Dependent Interface (MDI), was published as IEEE Std 802.3af™-2003, and is hereinafter referred to as the “IEEE standard”. The IEEE standard, whose contents are incorporated herein by reference, is commonly referred to as Power over Ethernet (PoE), and specifies methods and requirements for delivery of limited DC power using two of the four twisted-pairs contained within standard Ethernet cables. Equipment that supplies power on Ethernet cables are called Power Sourcing Equipment (PSE), of which there are two types, endspan and midspan, distinguishable by their location within the link segment. Any apparatus that utilizes power supplied by a PSE is called a Powered Device (PD).

The IEEE standard defines two wiring alternatives: “Alternative-A” (hereinafter referred to as “Alt-A”) wherein data and power are carried on the same wires; and “Alternative-B” (hereinafter referred to as “Alt-B”) wherein data and power are carried on separate wires. According to the IEEE standard, an endspan PSE may utilize either Alt-A or Alt-B, while a midspan PSE must utilize Alt-B only.

FIG. 1 shows a first example of prior art wherein a system 10a consists of: an Alt-A endspan PSE with a plurality of ports (only one such port 11a is shown for simplicity); a standard PD 12; and a network cable 13. The network cable 13 mates with the connectors 21 on the PSE port 11a and standard PD 12. (The term “standard” in this context indicates the PD complies with the IEEE standard.) Since the endspan PSE port 11a utilizes Alt-A, data and power are carried on the same two twisted-pairs 14 contained within the network cable 13. The other two twisted-pairs 15 are unused in this example. Ethernet data is carried between the two physical layer (PHY) controllers 16 as differential-mode signals on the twisted-pairs 14 via transformers 19 and 20. Power from the source 17a is carried as a common-mode signal on the same twisted-pairs 14, and the power is utilized by the load 18 within the standard PD 12.

Before proceeding further, it should be noted that in order simplify the explanation of how these systems operate, the detection and classification processes defined by the IEEE standard are skipped, and it is assumed in all cases that the PSE has successfully detected and classified the PD, and is supplying power to the PD. Thus the complex PSE power circuitry is represented in FIG. 1 as a simple voltage source 17a, and the complex PD load circuitry is represented as a simple constant-current load 18. The same simplifications are employed in all subsequent figures, and thus all figures depict simplified schematics.

FIG. 2 shows a second example of prior art wherein a system 10b consists of: an Alt-B endspan PSE with a plurality of ports (only one such port 11b is shown for simplicity); a standard PD 12; and a network cable 13. Since the endspan PSE port 11b utilizes Alt-B, two twisted-pairs 14 carry only data, and DC power from the source 17b is carried as a common-mode signal on the other two twisted-pairs 15.

FIG. 3 shows a third example of prior art wherein a system 30 consists of: an Ethernet switch with a plurality of ports (31 being one such port); a midspan PSE comprising a plurality of ports (32 being one such midspan PSE port); a standard PD 12; and two network cables. The Ethernet switch port 31 has no internal PoE power source, and provides only data, which the midspan PSE port 32 passes to the PD 12 on the Alt-A pairs 14. The power source 17b within the midspan PSE port 32 injects common-mode DC power onto the Alt-B pairs 15.

The prior art shown thus far in FIG. 1, FIG. 2, and FIG. 3 is all in accordance with the IEEE standard, and has at least two disadvantages: first, the power available to the PD 12 is severely limited by heating in the wires; and second, since only two twisted-pairs carry data, the bit-rate is limited to 100 Mbps (100Base-Tx).

FIG. 4 shows another example of prior art wherein a system 40 addresses the two disadvantages described above. The power limitation disadvantage is addressed by using two PSE ports 11a and 42 in tandem to power a new type of PD 41: This PD essentially consists of two isolated loads 18a and 18b within one unit, and is hereinafter referred to as a “dual-load PD”. A first source 17a powers the first load 18a, and a second source 17b powers the second load 18b. The system 40 utilizes all four twisted-pairs to carry current, thus effectively doubling the total power available to the dual-load PD 41. The data-rate limitation disadvantage is addressed by gigabit PHY controllers 43 and additional transformers 44, 45, and 46 that allow all four twisted-pairs to carry data with an aggregate bit-rate up to 1000 Mbps (1000Base-T).

The system 40 depicted in FIG. 4 has at least two disadvantages: first, the system 40 requires the user to have two PSE, an endspan PSE 11a and a midspan PSE 42; and second the endspan PSE must utilize Alt-A. Therefore, users who own an Alt-B endspan PSE have no upgrade path other than to start over with a new Alt-A endspan PSE.

### SUMMARY OF THE INVENTION

Accordingly, it is a principal objective of the present invention to overcome the disadvantages of prior art. This is provided in the present invention by methods and an apparatus for passively cross-coupling power between the Alt-A and Alt-B twisted-pairs, while maintaining Ethernet link.

The invention includes a method and an apparatus each with several embodiments, described below.

In one embodiment the method combines power from an Alt-B endspan PSE port, and a midspan PSE port. The method includes steps of: DC-coupling common-mode power from the Alt-B contacts of the endspan PSE port output connector to the Alt-A contacts of the midspan PSE port input connector; and AC-coupling differential-mode data signals from the Alt-A contacts of the endspan PSE port output connector to the Alt-A contacts of the midspan PSE port input connector. This method results in a system that can fully power a dual-load PD, even though both endspan and midspan PSE output power on Alt-B.

In another embodiment the method combines power from two midspan PSE ports. The first midspan PSE port may be either standard (meaning it complies with the IEEE standard) or nonstandard (meaning it contains the apparatus of the present invention and consequently does not comply with the IEEE standard), while the second midspan PSE port is nonstandard. The method includes steps of: DC-coupling power from the Alt-B contacts of the input connector on the second midspan PSE port to the Alt-A contacts of the output connector on the same midspan PSE port; AC-coupling differential-mode data signals from the Alt-A contacts of the input connector on the second midspan PSE port to the Alt-A contacts of the output connector on the same midspan PSE port; and connecting the output connector of the first midspan PSE port to the input connector of the second midspan PSE port with a network cable. This method results in a system wherein two midspan PSE ports are connected in tandem to fully power a dual-load PD.

In one embodiment the apparatus includes: two connectors, each containing contacts for Alt-A and Alt-B connections; transformers arranged to AC-couple differential-mode data signals between the Alt-A contacts of the first connector and the Alt-A contacts of the second connector; and circuit pathways that DC-couple common-mode power between the Alt-B contacts on the first connector and Alt-A contacts on the second connector.

In another embodiment, the apparatus includes additional circuit pathways that DC-couple common-mode power between the Alt-A contacts on the first connector and the Alt-B contacts on the second connector.

In yet another embodiment, the apparatus includes additional transformers arranged to AC-couple differential-mode data signals between the Alt-B contacts of the first connector and the Alt-B contacts of the second connector.

### BRIEF DESCRIPTION OF THE DRAWINGS

For a more complete understanding of the invention and to show how the same may be carried into affect, reference will now be made, purely by way of example, to the accompanying drawings:

FIG. 1 shows a simplified schematic diagram illustrating an example of prior art, where an Alt-A endspan PSE powers a standard PD;

FIG. 2 shows a simplified schematic diagram illustrating another example of prior art, where an Alt-B endspan PSE powers a standard PD;

FIG. 3 shows a simplified schematic diagram illustrating yet another example of prior art, where an midspan PSE powers a standard PD;

FIG. 4 shows a schematic diagram illustrating yet another example of prior art, where an Alt-A endspan PSE is used in tandem with a midspan PSE to power a dual-load PD;

FIG. 5 shows a simplified schematic diagram of a novel system and a first embodiment of the apparatus of the present invention;

FIG. 6 shows further details of the apparatus of FIG. 5;

FIG. 7 shows a simplified schematic diagram of another embodiment of the apparatus;

FIG. 8 shows a simplified schematic diagram of another novel system wherein the present invention is embodied within a nonstandard midspan PSE port; and

FIG. 9 shows a block diagram of another novel system illustrating how the present invention allows a dual-load PD to be fully powered from a single midspan PSE.

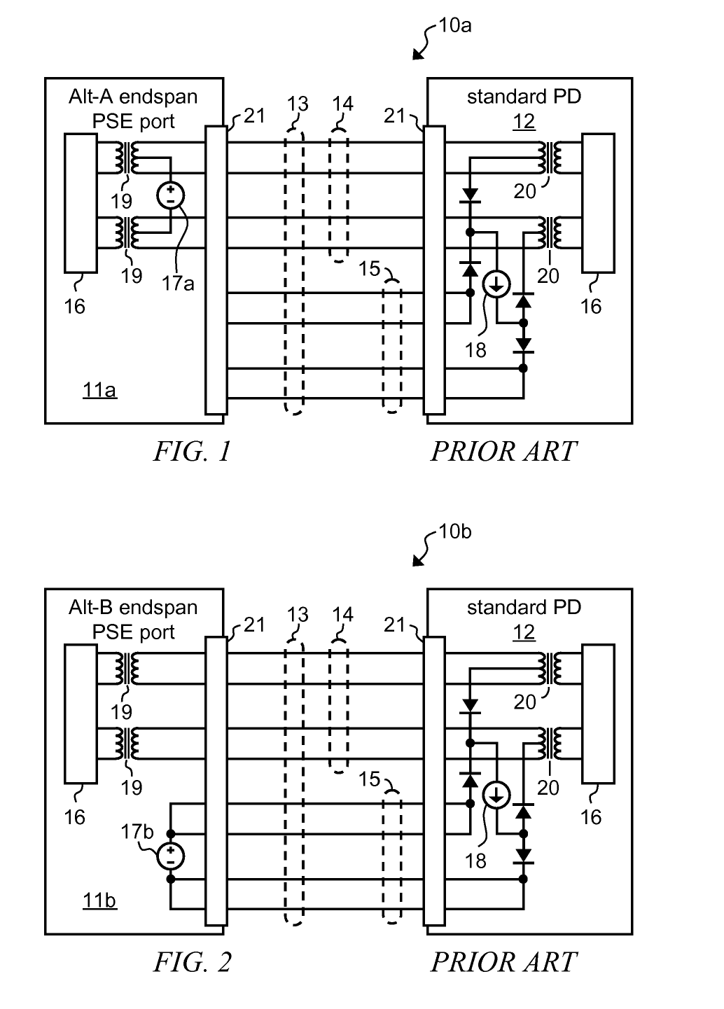

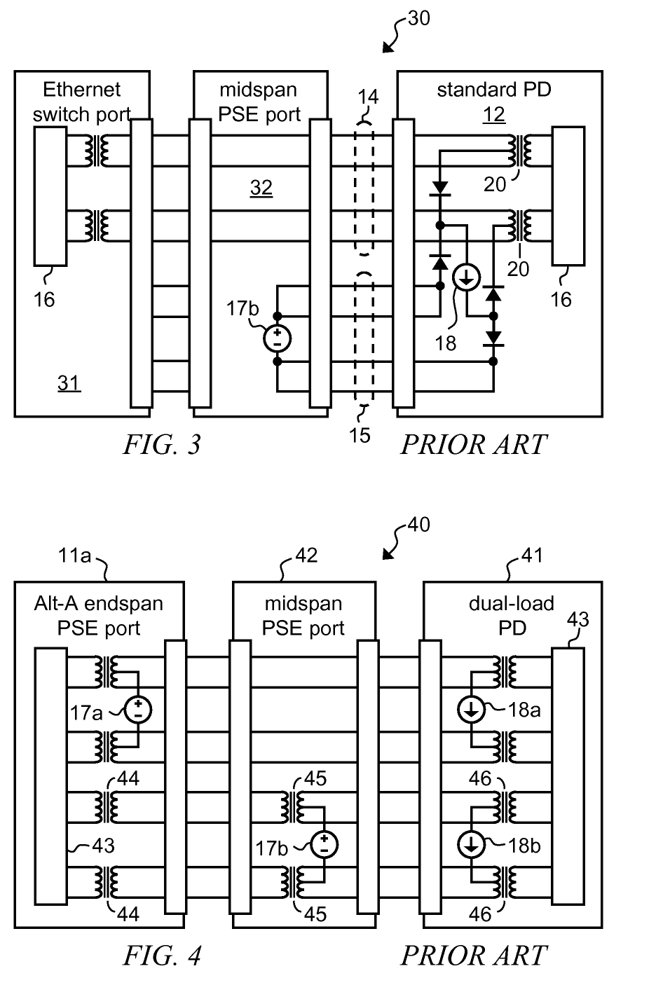

### DETAILED DESCRIPTION OF EXAMPLE EMBODIMENTS OF THE INVENTION

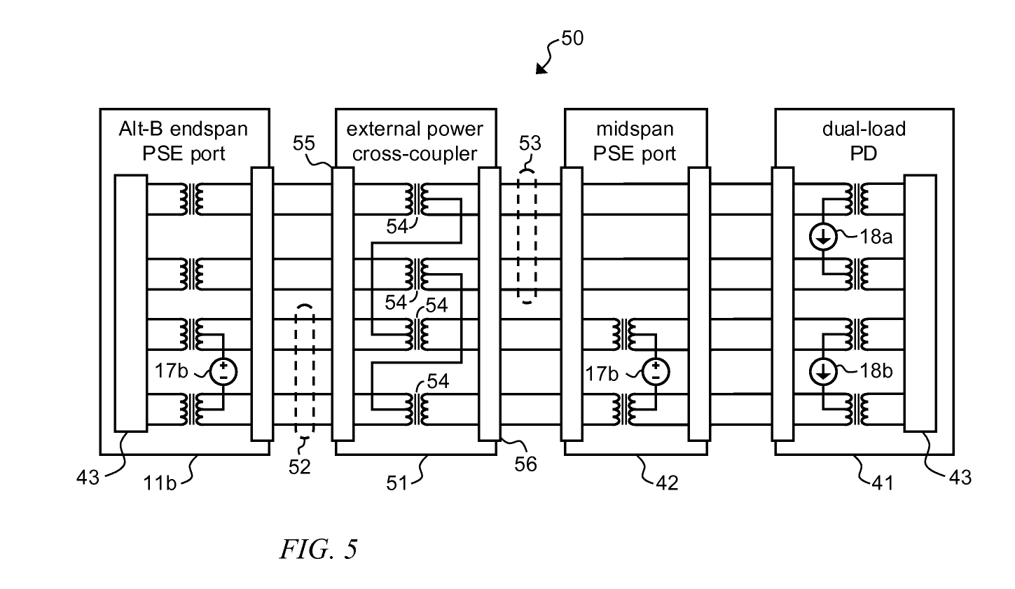

FIG. 5 shows a novel system 50 including a first embodiment of the apparatus of the present invention 51. Power from the endspan PSE port 11b is initially carried on the Alt-B pairs 52, and the power cross-coupler apparatus 51 transfers the power to the Alt-A pairs 53 via transformers 54; power then goes through the midspan PSE port 42 and thence to the first load 18a within the dual-load PD 41. The transformers 54 provide DC-coupling of common-mode power between 52 and 53, while also providing AC-coupling for differential-mode data signals to pass between the PHY devices 43. The invention 51 overcomes one of the disadvantages of the prior art of FIG. 4: Users who own Alt-B endspan PSE such as 11b are able to power a dual-load PD 41.

The apparatus 51 shown in FIG. 5 has a second application: it can be used to connect two ports of a standard midspan PSE in tandem to supply full power to a dual-load PD. If the endspan PSE port 11b in FIG. 5 were replaced with a midspan PSE port identical to the midspan PSE port shown 42, then the operation of the system 50 is essentially unchanged, and the dual-input PD 41 receives power for both its loads 18a and 18b.

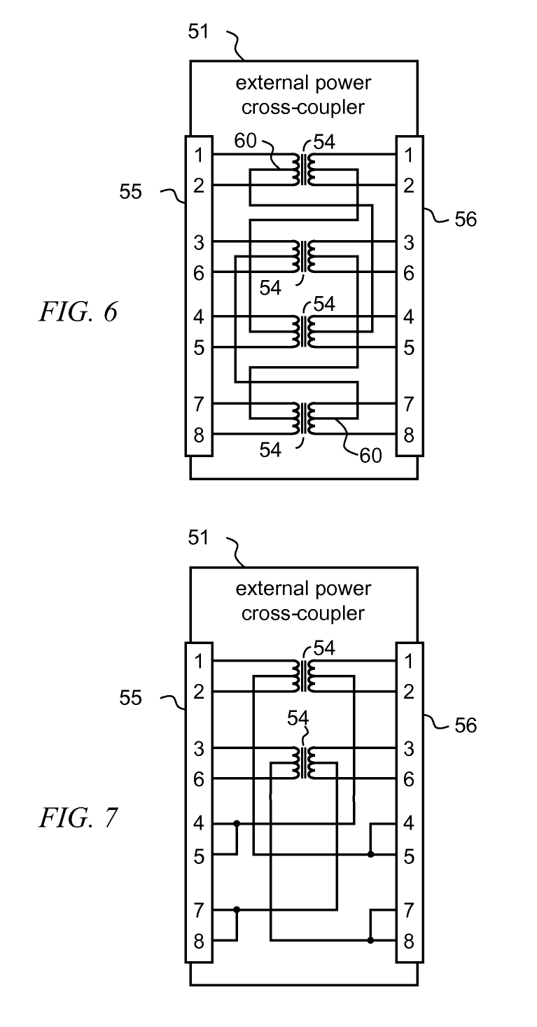

FIG. 6 depicts portions of the external power cross-coupler 51 of FIG. 5 in greater detail. For the purpose of example only, the two connectors 55 and 56 are assumed to be of the RJ45 type with pin assignments as defined in the IEEE standard, but the invention is not limited to this specific case. An important difference from the schematic of FIG. 5 is that the schematic of FIG. 6 includes two additional circuit pathways 60 that make the power cross-coupler 51 electrically symmetrical, such that either connector, 55 or 56, can mate with either PSE port.

FIG. 7 shows another embodiment similar the one shown in FIG. 6, but with two transformers removed to reduce cost. This embodiment is adapted for use in PoE systems that are limited to 100 Mbps (10Base-T or 100Base-Tx).

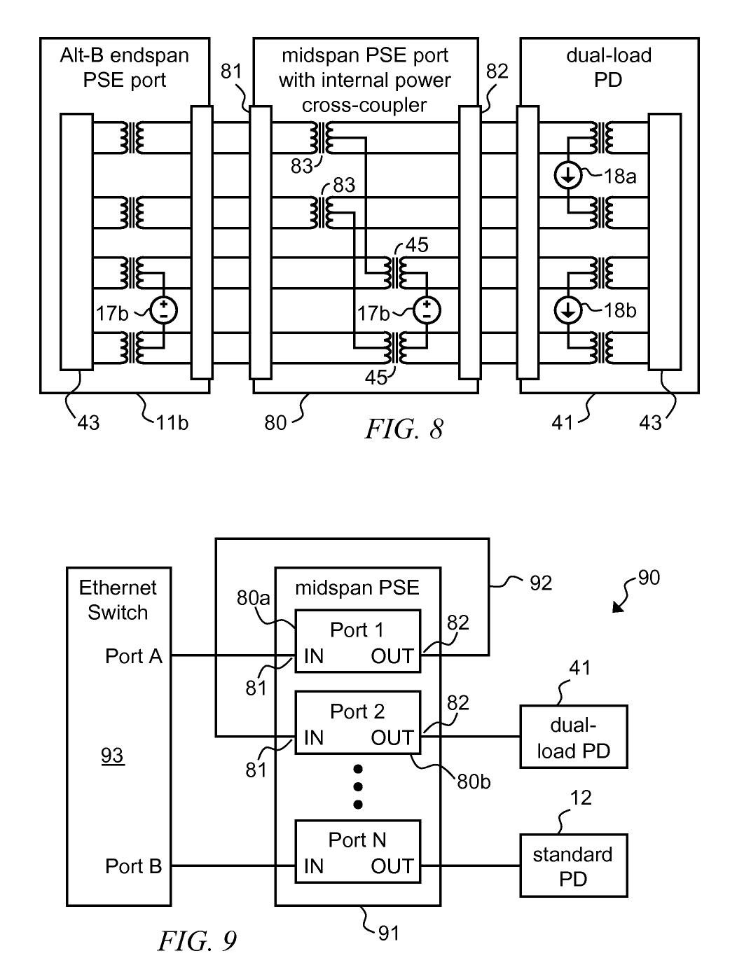

FIG. 8 depicts portions of another embodiment where the power cross-coupler apparatus is comprised within the midspan PSE port 80, thus making the midspan PSE port nonstandard. The nonstandard midspan PSE port 80 is similar to the standard midspan PSE port 42 depicted in FIG. 4, but with additional transformers 83, and connections to DC-couple common-mode power from the power source 17b inside the endspan PSE port 11b, to the first load 18a in the dual-load PD 41.

All the simplified schematics shown thus far have depicted basic transformers, but the invention is not limited to such devices, and apparatus with more sophisticated magnetics are also claimed. For example, transformers with multiple cores may be used to improved bit-error rates: The transformers 45 in FIG. 8 carry DC power from the endspan PSE port 11b on their primary windings, and DC power from the midspan PSE source on their secondary windings; this means that the transformers 45 are more vulnerable to the affects of DC current imbalances in the twisted-pairs, potentially seeing up to twice the worst-case flux bias seen by other transformers in the system such as 83. Flux bias results in a reduction of the inductance of the transformer, and can cause distortion of the differential-mode data signals passing through the transformers. To counter this vulnerability, each of the transformers 45 may comprise multiple cores: at least one core being used to AC-couple differential-mode data signals from primary to secondary; and at least one core configured as a center-tapped inductor in parallel with the primary winding, and used to extract the DC current which is then routed to transformers 83.

FIG. 9 shows another novel system 90 wherein the present invention overcomes another disadvantage of prior art by eliminating the need for two PSE in order to power a dual-load PD. In this example, an Ethernet switch 93, with no internal PoE power source, is used in conjunction with a nonstandard midspan PSE 91 with at least two ports 80a and 80b; each port is as illustrated by 80 in FIG. 8 with input connector 81, and output connector 82. A standard Ethernet cable 92 connects the output of the first midspan PSE port 80a to the input of the second midspan PSE port 80b; the resulting system is capable of fully powering the dual-load PD 41 with only a single midspan PSE 91. Furthermore, the system 90 is easily configurable by the user: Individual midspan PSE ports can power a standard PD 12, or any two ports can be connected in tandem with a standard cable such as 92 to power a dual-load PD.

Although the present invention has been described with several embodiments, a myriad of changes, variations, alterations, transformations, and modifications may be suggested by one skilled in the art, and it is intended that the present invention encompass such changes, variations, alterations, transformations, and modifications as they fall within the scope of the appended claims. Some examples of obvious changes, variations, alterations, transformations, and modifications include: packaging the apparatus 51 in the form of a cable assembly that can plug directly into two ports of a midspan PSE, or connect an endspan PSE port to a midspan PSE port; adding common-mode terminations or filters to the apparatus to reduce radiated emissions; or designing a midspan PSE that could be configured as either a standard midspan PSE (no cross-coupling) or as a cross-coupled midspan PSE (similar to 80 in FIG. 8) by selecting which components (jumpers, resistors, etc.) are stuffed on the circuit board, and which components are not stuffed.

What is claimed is:

1. A method of combining power from an endspan Power Sourcing Equipment (PSE) port and a midspan PSE port to power a Powered Device (PD) containing two loads, said endspan PSE port comprising an output connector, said midspan PSE port comprising an input connector and an output connector, each said connector further comprising a first group of contacts and a second group of contacts, each said PSE port operable to source common-mode DC power on said second group of contacts of its said output connector, said midspan PSE port further comprising circuit pathways connecting said first group of contacts of its input connector to said first group of contacts of its output connector, said method comprising steps of:
DC-coupling common-mode power from said second group of contacts on said output connector of said endspan PSE port to said first group of contacts on said input connector of said midspan PSE port; and
AC-coupling differential-mode data signals from said first group of contacts of said output connector of said endspan PSE port, to said first group of contacts of said input connector of said midspan PSE port.

2. The method of claim 1, and further comprising a step of AC-coupling differential-mode data signals from said second group of contacts of said output connector on said endspan PSE port, to said second group of contacts of said input connector on said midspan PSE port.

3. A method of combining power from a first midspan PSE port and a second midspan PSE port to power a PD containing two loads, each said midspan PSE port comprising an input connector and an output connector, each said connector further comprising a first group of contacts and a second group of contacts, each said midspan PSE port adapted to supply common-mode DC power on said second group of contacts of its said output connector, said method comprising steps of:
DC-coupling common-mode power from the second group of contacts of said input connector on said second midspan PSE port to said first group of contacts of said output connector on the same midspan PSE port;
AC-coupling differential-mode data signals from said first group of contacts of said input connector on said second midspan PSE port to said first group of contacts of said output connector on the same midspan PSE port;
connecting said output connector of said first midspan PSE port to said input connector of said second midspan PSE port with a network cable.

4. The method of claim 3, and further comprising a step of AC-coupling differential-mode data signals from said second group of contacts of said input connector on said second midspan PSE port to said second group of contacts of said output connector on the same midspan PSE port.

5. An apparatus for cross-coupling DC power in a PoE system while maintaining Ethernet link, said apparatus comprising:
a first connector containing a first group of contacts and a second group of contacts;
a second connector containing a first group of contacts and a second group of contacts;
a plurality of transformers, each said transformer having at least one primary winding connected to said first group of contacts on said first connector, and at least one secondary winding connected to said first group of contacts on said second connector; and
a plurality of circuit pathways arranged to DC-couple power from said second group of contact on said first connector to said first group of contacts on said second connector by way of connection to at least one of said secondary windings of said transformers.

6. The apparatus of claim 5 comprised within a midspan PSE.

7. The apparatus of claim 5 comprised within a cable assembly wherein said first connector is at one end of said cable assembly, and said second connector is at another end of said cable assembly.

8. At least one of the apparatus of claim 5 aggregated within a patch panel assembly.

9. The apparatus of claim 5 and further comprising at least one additional transformer, each said additional transformer having at least one primary winding connected to said second group of contacts on said first connector, and at least one secondary winding connected to said second group of contacts on said second connector.

10. The apparatus of claim 9 wherein said circuit pathways DC-couple power from said second group of contact on said first connector to said first group of contacts on said second connector by way of connection to at least one of said primary windings of said additional transformers.

11. The apparatus of claim 9 comprised within a midspan PSE.

12. The apparatus of claim 9 comprised within a cable assembly wherein said first connector is at one end of said cable assembly, and said second connector is at another end of said cable assembly.

13. At least one of the apparatus of claim 9 aggregated within a patch panel assembly.

14. The apparatus of claim 5, and further comprising a plurality of additional circuit pathways arranged to DC-couple power from said second group of contacts on said second connector to said first group of contacts on said first connector by way of connection to at least one of said primary windings of said transformers.

15. The apparatus of claim 13 comprised within a midspan PSE.

16. The apparatus of claim 13 comprised within a cable assembly wherein said first connector is at one end of said cable assembly, and said second connector is at another end of said cable assembly.

17. At least one of the apparatus of claim 13 aggregated within a patch panel assembly.

18. The apparatus of claim 9, and further comprising a plurality of additional circuit pathways arranged to DC-couple power from said second group of contacts on said second connector to said first group of contacts on said first connector by way of connection to at least one of said primary windings of said additional transformers.

19. The apparatus of claim 18 comprised within a midspan PSE.

20. The apparatus of claim 18 comprised within a cable assembly wherein said first connector is at one end of said cable assembly, and said second connector is at another end of said cable assembly.

21. At least one of the apparatus of claim 18 aggregated within a patch panel assembly.
